(19) United States
(12) Patent Application Publication
(10) Pub. No.: US 2014/0265616 A1
(43) Pub. Date: Sep. 18, 2014

(54) RESONATOR AND WIRELESS POWER TRANSMISSION DEVICE

(71) Applicant: KABUSHIKI KAISHA TOSHIBA, Tokyo (JP)

(72) Inventors: Shuichi OBAYASHI, Yokohama-Shi (JP); Akiko YAMADA, Yokohama-Shi (JP); Tetsu SHIJO, Tokyo (JP)

(73) Assignee: KABUSHIKI KAISHA TOSHIBA, Tokyo (JP)

(21) Appl. No.: 14/198,667

(22) Filed: Mar. 6, 2014

(30) Foreign Application Priority Data
Mar. 15, 2013 (JP) 2013-053458

(51) Int. Cl. H01F 38/14; H01F 27/24

(52) U.S. Cl. CPC H01F 38/14; H01F 27/24
USPC 307/104; 336/212

(57) ABSTRACT

According to an embodiment, there is provided a resonator including: a first magnetic material core, a first winding and a first protruding portion. The first magnetic material core includes at least one first core block of magnetic material. The first winding is wound around the first magnetic material core. The first protruding portion is formed so as to protrude from a part of the core block between a first end of the core block and the first winding.

### CROSS-REFERENCE TO _{RELATED} APPLICATIONS

This application is based upon and claims the benefit of priority from Japanese Patent Application No. 2013-053458, filed Mar. 15, 2013; the entire contents of which are incorporated herein by reference.

### FIELD

Embodiments described herein relate to a resonator and a wireless power transmission device.

### BACKGROUND

There is known a wireless power transmission device that has a primary resonator and a secondary resonator opposed to each other and performs wireless power transmission. The primary resonator and the secondary resonator are each constructed by winding coils around magnetic material cores. Each of the primary and secondary magnetic material cores includes of a plurality of cores that are spaced on a plane surface. This configuration tolerates the position shift in the same direction as the winding direction of the coil between the primary resonator and the secondary resonator, and further allows for a reduction in size and weight. However, there is a problem of a narrower allowable range for the position shift in the direction perpendicular to the winding direction of the coil (in the longitudinal direction of the coil).

### BRIEF DESCRIPTION OF THE DRAWINGS

FIG. 1 shows a wireless power transmission device according to a first embodiment;

FIG. 2 shows a position shift in the longitudinal direction of a coil in the first embodiment;

FIG. 3 shows a top view of a resonator and the dimensions thereof;

FIG. 4 shows a graph of the measurement result of the coupling coefficient when there is a position shift between two resonators;

FIG. 5 shows a position shift between a primary resonator and a secondary resonator;

FIG. 6 shows a magnetic field distribution when a primary resonator has no protruding portion;

FIG. 7 shows a magnetic field distribution when a primary resonator has a protruding portion;

FIG. 8 shows a position shift between a secondary resonator and a primary resonator when the secondary resonator is slightly smaller in dimension than the primary resonator;

FIG. 8A shows a position shift between a secondary resonator and a primary resonator when the primary resonator is slightly smaller in dimension than the secondary resonator;

FIG. 9 shows a position shift between a secondary resonator and a primary resonator whose coils are each wound at positions deviated from the centers of the core blocks;

FIG. 10 shows another example of a position shift between the secondary resonator and the primary resonator whose coils are each wound at the positions deviated from the centers of the core blocks;

FIG. 11 shows a wireless power transmission device according to a second embodiment;

FIG. 12 shows a position shift in the longitudinal direction of a coil in the second embodiment;

FIG. 13 shows a position shift when a primary resonator and a secondary resonator have the same dimensions;

FIG. 14 shows a position shift when a secondary resonator is slightly smaller in dimension than a primary resonator;

FIG. 15 shows a position shift between a secondary resonator and a primary resonator whose coils are each wound at positions deviated from the centers of the core blocks;

FIG. 16 shows another example of a position shift between the secondary resonator and the primary resonator whose coils are each wound at the positions deviated from the centers of the core blocks;

FIG. 17 shows modifications of the resonator;

FIG. 18 shows alternative modifications of the resonator;

FIG. 19 shows further alternative modifications of the resonator; and

FIG. 20 shows an example of a position shift between a primary resonator in which two coils are wound, and a secondary resonator in which one coil is wound.

### DETAILED DESCRIPTION

According to an embodiment, there is provided a resonator including: a first magnetic material core, a first winding and a first protruding portion.

The first magnetic material core includes at least one core block of magnetic material.

The first winding is wound around the first magnetic material core.

The first protruding portion is formed so as to protrude from a part of the core block between a first end of the core block and the first winding.

Hereinafter, embodiments will be described in detail with reference to the drawings.

### First Embodiment

FIG. 1 shows a wireless power transmission device according to a first embodiment. This wireless power transmission device includes a primary resonator and a secondary resonator.

FIG. 1(A) shows plan views of the primary resonator and the secondary resonator. FIG. 1(B) shows side views of the primary resonator and the secondary resonator, and FIG. 1(C) shows elevation views of the primary resonator and the secondary resonator.

The primary resonator 11 includes a magnetic material core 12 and a coil 13 as a winding wound around the magnetic material core 12. The magnetic material core 12 includes core blocks 14, 15 that are spaced from each other. The core blocks 14, 15 have a roughly flat plate shape, and are close to right and left ends of the inside of the coil 13. The coil 13 is wound such that the center of the coil 13 coincides or nearly coincides with the centers of the core blocks 14, 15. In the core blocks 14, 15, the parts around which the coil is wound and the vicinities thereof are inwardly widened. Since magnetic fluxes are concentrated to these parts at the time of power transmission, the widths is widened to decrease the core-loss. Furthermore, by narrowing the parts other than the parts around which the coil is wound, the quantity of the magnetic material is considerably decreased, leading to a weight reduction.

Protruding portions 14a, 14b are formed so as to protrude from core block parts between the coil 13 and one end and the other end of the core block 14. Similarly, protruding portions 15a, 15b are formed so as to protrude from core block parts between the coil 13 and one end and the other end of the core block 15. These protruding portions are formed, among the faces of each core block, on the face opposing the secondary resonator when the primary resonator is opposed to the secondary resonator. The protruding portions 14a, 14b may be formed of a magnetic material having a greater coercive force than the core block 14. The protruding portions 15a, 15b may be formed of a magnetic material having a greater coercive force than the core block 15.

The secondary resonator 51 has the same configuration as the primary resonator, except that the protruding portions are not formed. That is, the secondary resonator 51 includes a magnetic material core 52 and a coil 53 wound around the magnetic material core 52. The magnetic material core 52 includes core blocks 54, 55 that are spaced from each other. The core blocks 54, 55 are close to the right and left ends of the inside of the coil 53. The core blocks 54, 55 have a roughly flat plate shape. The coil 53 is wound such that the center thereof coincides or nearly coincides with the centers of the core blocks. In the core blocks 14, 15, the parts around which the coil is wound and the vicinities thereof are inwardly widened.

In FIG. 1, reference character “D1” denotes the dimension (the distance) from one end or the other end of the core block of the primary resonator to the center thereof (more specifically, a center of a core block part wound by the coil in a longitudinal direction of the core block), and reference character “D2” denotes the dimension (the distance) from one end or the other end of the core block of the secondary resonator to the center thereof (more specifically, a center of a core block part wound by the coil in a longitudinal direction of the core block).

Now, the position shift that can occur between the primary resonator and the secondary resonator when they are opposed at the time of power transmission, will be described. The position shift includes the position shift in the width direction of the coil (in the winding direction of the coil) and the position shift in the longitudinal direction of the coil (in the direction perpendicular to the winding direction of the coil). When the primary resonator and the secondary resonator are opposed such that the centers in the longitudinal direction and width direction of the coil coincide respectively, they are in a state in which there is no position shift in either direction.

FIG. 2 shows a state in which the position shift occurs in the longitudinal direction of the coil between the primary resonator 11 and the secondary resonator 51. In the embodiment, as one feature, by means of the protruding portions formed on the core blocks in the primary resonator 11, it is possible to maintain a high coupling coefficient, even when the position shift in the longitudinal direction of the coil occurs. The maintenance of a high coupling coefficient allows for a high transmission efficiency.

FIG. 3(A) shows a top view of a resonator that has the same configuration as the secondary resonator shown on the left in FIG. 1(A), and the dimensions thereof. The width direction of the coil of the resonator is shown as the x-axis, and the longitudinal direction is shown as the y-axis. FIG. 3(B) is a cross-sectional view showing the position shift in the x-axis direction (in the width direction of the coil) when two of same resonator as that shown in FIG. 3(A) are prepared and are opposed. Here, the protruding portion is not formed in either resonator. The embodiment mainly intends to increase the tolerance to the position shift especially in the y-axis direction out of the x-axis direction and y-axis direction (longitudinal direction of the coil) in particular.

FIG. 4 shows a graph of the measurement result of the coupling coefficient when two of same resonator as that shown in FIG. 3(A) are disposed so as to be opposed and then the position shift occurs in the x-axis and y-axis direction. The full line graph is a relational graph of the position shift in the x-axis direction and the coupling coefficient, and the broken line graph is a relational graph of the position shift in the y-axis direction and the coupling coefficient. The abscissa represents the length of the position shift, and the ordinate represents the value of the coupling coefficient, The distance between the opposing coils is 150 mm.

The efficiency between the coils depends on the product of the coupling coefficient “k” and the “Q” value. In the case of using a resonator with “Q”=200, the coupling coefficient “k”>0.15 results in the efficiency between the coils >95%. When setting the coupling coefficient “k”=0.15 or more as a standard, the allowable range of the position shift is up to 150 mm for the x-axis direction, and 100 mm for the y-axis direction. The reason why the allowable range for the y-axis direction is small is that there is a point at which the sum of the magnetic fluxes passing through the secondary coil is 0. In the example shown in the figure, when the position shift in the y-axis direction is 200 mm, a decrease in the coupling coefficient occurs due to canceling out of magnetic fluxes. This position shift in the y-axis direction corresponds to 43% of the dimension (460 mm) in the y-axis direction. This coupling property depends on the outside dimensions of the resonator.

Here, the distance from the end of the core block in the secondary resonator to the center of the core block is represented as “D(A)” (in the example of FIG. 3, “D(A)” is 230 mm). In this case, if it is possible to improve the coupling coefficient up to approximately 0.15 when the position shift in the y-axis direction is “D(A)/2”, the influence of the position shift becomes equivalent to that in the x-axis direction, and it is possible to improve the efficiency. That is, it is possible to improve the tolerance to the position shift in the y-axis direction, up to the same level as that in the x-axis direction. On the assumption that the maximal length of the position shift occurring in normal use is “D(A)/2”, consideration is given to the improvement of the coupling coefficient at this time up to approximately 0.15.

FIG. 5 shows a state of the position shift in y-axis direction, in the primary resonator and secondary resonator shown in FIG. 1. Hereinafter, in some cases, the primary resonator according to the embodiment is collectively referred to as the primary resonator B, and the secondary resonator is collectively referred to as the secondary resonator A. Here, for simplification, it is assumed that there is no position shift in the x-axis direction. The two resonators have the same dimensions. Reference character “D(A)” denotes the distance from the end of the core block to the center of the core block. The example in the figure shows a state in which the position shift in the y-axis direction is half of “D(A)”. In this example, in both resonators, the centers of the coils coincide with the centers of the core blocks.

Suppose that the protruding portion is not present in the primary resonator B. In this case, if there is no position shift, the strongest magnetic coupling is generated between the ends of the core blocks of both resonators. However, once the position shift occurs in this state, the magnetic coupling between the ends decreases depending on the position shift. Hence, the embodiment solves this problem by providing the protruding portion in the primary resonator B. By forming the protruding portion in the primary resonator, the distance between this protruding portion and the end of the secondary resonator A becomes close at the time of the position shift. Thereby, a strong magnetic coupling is generated between these, and this magnetic coupling compensates for the decrease in the magnetic coupling between the ends. Specifically, in the example shown in the figure, the magnetic coupling 502 by the protruding portion on the left in the paper plane compensates for the decrease in the magnetic coupling 501 between the left-side ends. Electromagnetism has the property of strongly coupling with an edge part. Therefore, by forming the protruding portion, edge points are formed other than both ends of the core block, and by utilizing these, the decrease in the magnetic coupling at the time of the position shift is suppressed.

FIG. 6 shows a magnetic field distribution when the primary resonator has no protruding portion, and FIG. 7 shows a magnetic field distribution when the primary resonator has a protruding portion. These magnetic field distributions were obtained by a simulation. At the time of the position shift, the magnetic coupling between the protruding portion and the end of the secondary resonator compensates for the decrease in the magnetic coupling between the ends. Thereby, the decrease in the coupling is suppressed as a whole. Here, in this example, the side cross-sectional shape of the protruding portion is a triangular shape, unlike the rectangular shape described earlier. Thus, the shape of the protruding portion may be arbitrary.

Now, the disposing position of the protruding portion will be described. As shown in FIG. 5, the distance from the end of the core block of the secondary resonator A to the center thereof is represented as “D(A)”. The distance from the end of the core block of the primary resonator B to the center thereof is represented as “D(B)”. In this case, preferably, the protruding portion should be formed at a position in the range of {D(B)-D(A)/2} from the end of the core block of the primary resonator B. For example, it is formed such that the coil-side end of both ends of the protruding portion is within the range.

If, beyond the range, the protruding portion is provided on the side closer to the coil, the position of the protruding portion goes over the center of the coil of the secondary resonator when the position shift in the y-axis direction exceeds one-half of “D(A)”. In this case, there is a possibility that the coupling 503 is generated between the mutually different sides of the primary and secondary core blocks with respect to the coils. This coupling is a coupling with the opposite polarity to the proper magnetic coupling, that is, a coupling between positives or between negatives, and reduces the proper coupling, resulting in a decrease in transmission efficiency.

Therefore, preferably, the position “P1” of the protruding portion should be a position in the range of {D(B)-D(A)/2} from the end of the core block. The same goes for the position of the protruding portion that is on the opposite side across the coil. In terms of suppression of the decrease in the coupling coefficient when the position shift in the y-axis direction occurs, it is effective that the protruding portion is disposed at a position apart from the end of the core block.

In the example shown in FIG. 5, the primary and secondary resonators have the same dimensions. The case where the secondary resonator A is smaller in the dimension in the longitudinal direction of the coil than the primary resonator B, will be discussed.

FIG. 8 shows a configuration in which the secondary resonator A is smaller in the dimension in the longitudinal direction of the coil than the primary resonator B. In this case, suppose that the position shift in the longitudinal direction of the coil is half of “D(A)”. In order to avoid the coupling 803 with the opposite polarity to the proper magnetic coupling, similarly to the example in FIG. 5, it is preferable that each of the positions “P2(1)”, “P2(2)” of the protruding portions be a position in the range of {D(B)-D(A)/2} from a respective one of ends of the core block. Even when the position shift reaches one-half of “D(A)”, the magnetic coupling 802 between the protruding portion of the primary resonator B and the end of the secondary resonator A compensates for the decrease in the magnetic coupling 801 between the ends.

FIG. 8A shows a configuration in which the primary resonator B is smaller in the dimension in the longitudinal direction of the coil than the secondary resonator A. In this case, also, in order to avoid the coupling 803a with the opposite polarity to the proper magnetic coupling, it is preferable that each of the positions “P2a(1)”, “P2a(2)” of the protruding portions be a position in the range of {D(B)-D(A)/2} from a respective one of ends of the core block. Even when the position shift reaches one-half of “NA)”, the magnetic coupling 802a between the protruding portion of the primary resonator B and the end of the secondary resonator A compensates for the decrease in the magnetic coupling 801a between the ends.

In the examples shown earlier, in both primary side and secondary side, the centers of the coils coincide with the centers of the core blocks. In the following, the case where the centers of the coils are deviated from the centers of the core blocks will be described.

As shown in FIG. 9, in both of the secondary resonator A on the upper side and the primary resonator B on the lower side, the coils are each wound at positions deviated from the centers of the core blocks. In the secondary resonator A, the coil is wound on the front side relative to the center, and in the primary resonator B, also, the coil is wound on the front side relative to the center. Here, the left side in the paper plane is the front side, and the right side in the paper plane is the back side that is opposite to the front side.

The case where the secondary resonator A is position-shifted to the front side relative to the primary resonator B will be discussed. In the primary resonator B, the distance from the front-side end of the core block to the center of the coil is represented as “Df(B)”. In the secondary resonator A, the distance from the back-side end of the core block to the center of the coil is represented as “Db(A)”,

Here, the case where the position shift is half of “Db(A)” will be discussed. In order to avoid the coupling 1403 with the opposite polarity to the proper magnetic coupling, it is preferable that the position “P3” of the protruding portion on the front side be a position in the range of {Df(B)-Db(A)/2} from the end on the front side of the core block.

Even when the position shift reaches one-half of “Db(A)”, the magnetic coupling 1402 with the back-side end of the core block of the secondary resonator A by the protruding portion formed on the back side compensates for the decrease in the magnetic coupling 1401 between the back-side ends. The condition of the position of the protruding portion on the back side will be described in the following FIG. 10.

In the example shown in FIG. 9, the secondary resonator is position-shifted to the front side relative to the primary resonator. The case of being position-shifted to the back side will be discussed, FIG. 10 shows a situation in this case. The distance from the front-side end of the core block of the secondary resonator A to the center of the coil is represented as “Df(A)”. The distance from the back-side end of the core block of the primary resonator B to the center of the coil is represented as “Db(B)”.

The case where the position shift to the back side is half of “Df(A)” will be discussed. In order to avoid the coupling 1503 with the opposite polarity to the proper magnetic coupling, it is preferable that the position “P4” of the protruding portion be a position in the range of {Db(B)-Df(A)/2} from the back-side end of the core block.

Even when the position shift reaches one-half of “Df(A)”, the magnetic coupling 1502 with the end of the secondary resonator A by the protruding portion formed on the front side compensates for the decrease in the magnetic coupling 1501 between the ends.

Here, in the case where, in both the secondary resonator A and the primary resonator B, the coils are wound at positions deviated from the centers of the core blocks, preferably, the core blocks should be placed such that the front-back directions of the longer parts and shorter parts are the same for the two coils. Thereby, it is expected that the degradation of the coupling coefficient by the position shift is reduced.

The magnetic material cores blocks of the resonators shown earlier have a flat plate shape, but can have other various shapes.

FIG. 17 shows side views showing examples of resonators in which the protruding portions are formed on core blocks having other shapes.

In FIG. 17(A), the thickness of both ends of a core block is thinned, leading to a weight reduction. Reference characters A1, A2 denote the protruding portions.

In FIG. 17(B), the thickness of the part around which the coil is wound is increased in a step shape compared to other parts. Reference characters B1, B2 denote the protruding portions.

In FIG. 17(C), the thickness of a core block is uniform as a whole, but both end parts are offset to the upper side by approximately half of the thickness. Thereby, the distance to the opposing resonator is reduced, leading to an increase in the coupling coefficient. Reference characters C1, C2 denote the protruding portions.

In FIG. 17(D), the thickness of a core block is increased as being closer to the center. The coil is wound around the center part that is the thickest part. The core block has a vertically-symmetric shape as a whole. Reference characters D1, D2 denote the protruding portions.

In FIG. 17(E), although the thickness of a core block is changed so as to be increased as being closer to the center, the core block has a vertically-asymmetric shape as a whole, unlike FIG. 17(D). Reference characters E1, E2 denote the protruding portions.

Other than shown in FIG. 17, as for the shape of the core block on which the protruding portions are formed, various modifications are possible. In particular, FIG. 18 shows modifications with respect to the plane shape.

In FIG. 18(A), in each of right and left core blocks, the width of the center part is widened to the outside. Reference characters A1, A2, A3, and A4 denote the protruding portions.

In FIG. 18(B), in each of right and left core blocks, the width of the center part is widened both to the inside and to the outside. Reference characters B1, B2, B3, and B4 denote the protruding portions.

In FIG. 18(C), in each of right and left core blocks, the width is uniform over the whole. Reference characters C1, C2, C3, and C4 denote the protruding portions.

In FIG. 18(D), in each of right and left core blocks, the width is gradually inwardly widened as being closer to the center part, and is constant near the center. Reference characters D1, D2, D3, and D4 denote the protruding portions.

In FIG. 18(E), in each of right and left core blocks, the width is gradually widened to the outside as being closer to the center, and is constant near the center. Reference characters E1, E2, E3, and E4 denote the protruding portions. In FIG. 18(F), in each of right and left core blocks, the width is gradually widened both to the inside and to the outside as being closer to the center part, and is constant near the center. Reference characters F1, F2, F3, and F4 denote the protruding portions.

In FIG. 18(G), in each of right and left core blocks, the widths of the center part and both end parts are widened to the outside. Reference characters G1, G2, G3, and G4 denote the protruding portions.

In FIG. 18(H), in each of right and left core blocks, the widths of the center part and both end parts are inwardly widened. Reference characters H1, H2, H3, and H4 denote the protruding portions.

In FIG. 18(I), FIG. 18(3) and FIG. 18(K), a plurality of coils are wound around a pair of core blocks at an interval. That is, the winding of the magnetic material core includes the plurality of coils that are spaced from each other, By winding the coils at a plurality of positions, it is possible to disperse positions at which temperature rises.

In FIG. 18(I), in the core block, the widths of the parts around which two coils are wound are inwardly widened. Both ends are narrowed in a tapered shape, leading to a weight reduction. Reference characters I1, 12, 13, and 14 denote the protruding portions.

In FIG. 18(3), also, in each of right and left core blocks, the widths of the parts around which two coils are wound are inwardly widened. The parts around which the coils are wound are concentrated to the center of the core block, Reference characters 31, 32, 33, and 34 denote the protruding portions.

In FIG, 18(K), in each of right and left core blocks, the widths of the parts around which two coils are wound are inwardly widened, The widths of both ends are narrowed in a step shape, leading to a weight reduction, Reference characters K1, K2, K3, and K4 denote the protruding portions.

In the examples described earlier, the number of the core blocks included in the primary and secondary resonators is two, but may be three or more, or may be one. Examples thereof will be shown as follows,

FIG. 19(A), FIG. 19(B), FIG. 19(C), FIG. 19(D), FIG. 19(E) and FIG. 19(F) show examples in which the number of the core blocks is three. In FIG, 19(A) to FIG. 19(D), three core blocks are spaced from each other. In FIG. 19(E) and FIG. 19(F), three core blocks are combined to be unified, and the central core block has a smaller dimension in the longitudinal direction of the coil than both sides. In FIG, 19(A) to FIG. 19(D), the protruding portions are formed on each of the three core blocks. Reference characters A1, A2, A3, A4, A5, A6, B1, B2, B3, B4, B5, B6, C1, C2, C3, C4, C5, C6, D1, D2, D3, D4, D5 and D6 denote the protruding portions. In FIG. 19(E), the protruding portions E1, E2, E3, and E4 are formed only on the core blocks on both sides. In FIG. 19(F), protruding portions F1, F2 having an oblong shape in the paper plane are formed across the three core blocks. The thickness of each core block shown in FIG. 19(A) to FIG. 19(F) may be uniform, or the various modifications shown in FIG. 17 may be used,

In FIG. 19(G), the number of the core blocks is one. In FIG. 19(G), at the center of a longitudinal core block, two coils are spaced from each other. The protruding portions G1, G2 are formed at positions slightly apart from both ends of the single core block to the coil side. In FIG. 19(H), a single coil is wound around the center of a single magnetic material core having a flat plate shape. Protruding portions H1, H2 having an oblong shape in the paper plane are formed at positions slightly apart from both ends of the magnetic material core to the coil side, The thickness of the core block or magnetic material core may be uniform, or the various modifications shown in FIG. 17 may be used.

Now, the position of the protruding portion in the case where two coils are wound around the core blocks as FIG. 18(I), FIG. 18(J) and FIG. 18(K) will be discussed.

As shown in FIG, 20, in the secondary resonator A on the upper side, two coils are wound at an interval as the winding of the magnetic material core. The coils are wound at positions the same distance “L1” apart from the center of the core block to the front side and back side. The number of turns and the wire interval are the same for the coils. As for the primary resonator B on the lower side, similarly to the earlier things, a single coil is wound and the protruding portions are formed on both sides from the coil. In the primary resonator B, the center of the coil coincides with the center of the core block.

The case where the secondary resonator A is position-shifted to the back side relative to the primary resonator B will be discussed. In this case, assuming that the center of the core block part between the two coils corresponds to the center of the winding, the protruding portion may be formed in the same range as described in FIG. 5 and FIG. 8. That is, in the primary resonator, preferably, the protruding portion should be disposed at a position “P30” that is in the range of {D(B)-D(A)/2} from the end of the core block. The same goes for the position of the protruding portion that is on the opposite side across the coil.

In the example shown in FIG. 20, the center of the core block part between the two coils coincides with the center of the core block, but, in some cases, the center of the core block part between the two coils does not coincide with the center of the core block. In such cases, also, assuming that the center of the core block part between the two coils corresponds to the center of the winding, the protruding portion may be formed in the same range as described in FIG. 9 and FIG. 10.

In the embodiment described above, the protruding portions are formed on both sides from the coil, respectively. However, the protruding portion may be formed only on either side. This is effective particularly when it is expected that the position shift occurs only to either of the front side and the back side.

In the embodiment, on each of both sides from the coil, only one protruding portion is formed, but two or more protruding portions may be formed. Also, for each of both sides from the coil, different numbers of protruding portions may be formed.

In the embodiment, the protruding portion is formed on the face (front face) opposing the secondary resonator, among the faces of the core block. However, the protruding portion may be formed on other faces, for example, on either or both of the two side faces of the core block. Also, the protruding portion may be formed so as to overlap both of the front face of the core block and one or the other side face of the core block,

From the above, according to the embodiment, even when the position shift in the direction perpendicular to the winding direction of the coil occurs to some extent, it is possible to suppress the decrease in the coupling coefficient between the resonators.

Here, in the first embodiment, a mode in which the protruding portion is provided in the primary resonator and is not provided in the secondary resonator has been shown. However, a mode in which the protruding portion is provided in the secondary resonator and is not provided in the primary resonator is also allowable.

### Second Embodiment

FIG. 11 shows a wireless power transmission device according to a second embodiment, The difference from the first embodiment is that the protruding portion is formed on the core block of the secondary resonator as well as of the primary resonator. The other constituents are the same as the first embodiment, Therefore, the same reference characters are assigned to the same or corresponding elements, and repetitive descriptions are omitted.

In a secondary resonator 61, protruding portions 54a, 54b are formed on a core block 54, and protruding portions 55a, 55b are formed on a core block 55. More specifically, the protruding portions 54a, 54b are formed so as to protrude from core block parts between one end and the other end of the core block 54 and the coil 53. The protruding portions 54a, 54b are formed at positions apart from one end and the other end of the core block 54. Similarly, the protruding portions 55a, 55b are formed so as to protrude from core block parts between one end and the other end of the core block 55 and the coil 53. The protruding portions 55a, 55b are formed at positions apart from one end and the other end of the core block 55.

These protruding portions in the secondary resonator are formed, among the faces of the core block, on the face opposing the primary resonator when it is aligned with the other. However, similarly to the primary resonator described in the first embodiment, the face on which the protruding portions are formed may be other faces. The protruding portions 54a, 54b may be formed of a magnetic material having a greater coercive force than the core block 54. The protruding portions 55a, 55b may be formed of a magnetic material having a greater coercive force than the core block 55.

FIG. 12 shows a state in which the position shift occurs in the longitudinal direction of the coil between the primary resonator and secondary resonator shown in FIG. 11. In the embodiment, by forming the protruding portion on the core block of the secondary side as well as of the primary side, it is possible to maintain a further high coupling coefficient, even when the position shift in the longitudinal direction of the coil occurs. This achieves a further high transmission efficiency.

FIG. 13 shows the case where the primary resonator B on the lower side and the secondary resonator A on the upper side have the same dimensions and the secondary resonator A is position-shifted to the back side by half of “D(A)”. In both the primary resonator B and the secondary resonator A, the centers of the coils coincide with the centers of the core blocks, respectively. Reference character “D(A)” denotes the distance from one end of the core block of the secondary resonator A to the center thereof.

Suppose that the protruding portion is not formed in the secondary resonator A. In this case, if there is no position shift, in both sides of the core blocks of both resonators, the ends magnetically couple with each other most strongly. However, once the secondary resonator is position-shifted to the back side in this state, the magnetic coupling between the back-side ends greatly decreases. Hence, the embodiment solves this problem by providing the protruding portion in the secondary resonator A. That is, in the case of being position-shifted to the back side, the distance between the protruding portion on the back side of the secondary resonator A and the end on the back side of the primary resonator B becomes close, and the magnetic coupling 1202 between these compensates for the decrease in the magnetic coupling 1201 between the ends on the back side. Furthermore, similarly to the first embodiment, the distance between the protruding portion on the front side of the primary resonator and the end on the front side of the secondary resonator becomes close, and the magnetic coupling 1102 between these compensates for the decrease in the magnetic coupling 1101 between the ends on the front side. Therefore, the decrease in the magnetic coupling is suppressed.

Now, the position of the protruding portion formed in the secondary resonator will be described. The distance from the end of the core block of the secondary resonator A to the center of the coil is represented as “D(A)”. The distance from the end of the core block of the primary resonator B to the center of the coil is represented as “D(B)”. Similarly to the first embodiment, the position “P5” of the protruding portion of the primary resonator B is in the range of {D(B)-D(A)/2} from the end of the core block. The position “P6” of the protruding portion of the secondary resonator A is a position in the range of {D(A)/2} from the end of the core block.

If the protruding portion is provided beyond {D(B)-D(A)/2} from the end of the core block of the primary resonator B, or the protruding portion is provided beyond {D(A)/2} from the end of the core block of the secondary resonator A, the position of the protruding portion exceeds the center of the counter resonator. In this case, there is a possibility that the coupling 1103 or 1104 between the mutually opposite sides of the core blocks is generated between the primary and secondary resonators A, B. This coupling, which is a coupling with the opposite polarity to the proper magnetic coupling, reduces the proper coupling, and thereby decreases the transmission efficiency.

Therefore, preferably, the position of the protruding portion of the secondary resonator A should be in the range of {D(A)/2} from the end of the core block, and the position of the protruding portion of the primary resonator B should be in the range of {D(B)-D(A)/2} from the end of the core block.

In the example shown in FIGS. 11 to FIG, 13, the primary and secondary resonators have the same dimensions.

The case where the secondary resonator A is smaller in the dimension in the longitudinal direction of the coil than the primary resonator B can be also discussed similarly,

FIG. 14 shows a position shift in the case where the secondary resonator A on the upper side is slightly smaller in the dimension in the longitudinal direction of the coil than the primary resonator B on the lower side. In this case, suppose that the position shift in the longitudinal direction of the coil is half of “D(A)”. Here, in both the primary side and the secondary side, the centers of the coils coincide with the centers of the core blocks.

In order to avoid the coupling 1203, 1204 with the opposite polarity to the proper magnetic coupling, preferably, the position “P10” of the protruding portion of the primary resonator B should be in the range of {D(B)-D(A)/2} from the end of the core block. The same goes for the protruding portion that is on the opposite side across the coil. Preferably, the position “P11” of the protruding portion of the secondary resonator A should be a position in the range of {D(A)/2} from the end of the core block. The same goes for the protruding portion that is on the opposite side across the coil.

Even when the position shift reaches one-half of “D(A)”, the magnetic coupling 1205 between the protruding portion on the back side of the secondary resonator A and the end on the back side of the primary resonator B compensates for the decrease in the magnetic coupling 1206 between the ends.

Similarly to the first embodiment, the magnetic coupling 1202 between the protruding portion on the front side of the primary resonator B and the end on the front side of the secondary resonator A compensates for the decrease in the magnetic coupling 1201 between the ends.

In the examples shown earlier, in both the primary resonator and the secondary resonator, the centers of the respective coils coincide with the centers of the core blocks. In the following, the case where, in both of the primary and secondary resonators, the coils are wound at positions deviated from the centers of the core blocks will be shown.

As shown in FIG. 15, in both of the secondary resonator A and the primary resonator B, the coils are wound at positions deviated from the centers of the core blocks. In the secondary resonator A, the coil is wound on the front side relative to the center of the core block, and in the primary resonator B, also, the coil is wound on the front side relative to the center of the core block.

The case where the secondary resonator A is position-shifted to the front side relative to the primary resonator B will be discussed. In the secondary resonator A, the distance from the back-side end of the core block to the center of the coil is represented as “Db(A)”. In the primary resonator B, the distance from the front-side end of the core block to the center of the coil is represented as “Df(B)”. The case where the secondary resonator is position-shifted to the front side by half of “Db(A)” will be discussed. In order to avoid the coupling 1603, 1604 with the opposite polarity to the proper magnetic coupling, preferably, the position “P12” of the protruding portion on the front side of the primary resonator B should be in the range of {Df(B)-Db(A)/2} from the end on the front side of the core block. Preferably, the position “P13” of the protruding portion on the back side of the secondary resonator A should be in the range of {Db(A)/2} from the end on the back side of the core block.

Even when the length of the position shift reaches one-half of “Db(A)”, the magnetic coupling 1602 between the protruding portion on the back side of the core block of the primary resonator B and the end on the back side of the secondary resonator A compensates for the decrease in the magnetic coupling 1601 between the ends. Similarly, the magnetic coupling between the end on the front side of the core block of the primary resonator B and the protruding portion on the front side of the secondary resonator A compensates for the decrease in the magnetic coupling between the ends on the front side. Thereby, a high coupling coefficient state is maintained.

In this example, the secondary resonator is position-shifted to the front side relative to the primary resonator. The case of being position-shifted to the back side will be discussed. FIG. 16 shows a situation in this case.

The distance from the front-side end of the core block of the secondary resonator A to the center of the coil is represented as “Df(A)”. The distance from the back-side end of the core block of the primary resonator B to the center of the coil is represented as “Db(B)”. The case where the secondary resonator is position-shifted to the back side by half of “Df(A)” will be discussed. In order to avoid the coupling 1703, 1704 with the opposite polarity to the proper magnetic coupling, preferably, the position “P15” of the protruding portion on the back side of the primary resonator B should be in the range of {Db(B)-Df(A)/2} from the end on the back side of the core block. Preferably, the protruding portion on the front side of the secondary resonator A should be at a position in the range of {Df(A)/2} from the end of the core block.

Even when the position shift to the back side reaches one-half of “Df(A)”, the magnetic coupling 1702 between the protruding portion on the front side of the primary resonator B and the end on the front side of the core block of the secondary resonator A compensates for the decrease in the magnetic coupling 1701 between the ends on the front side. Similarly, the magnetic coupling between the end on the back side of the primary resonator B and the protruding portion on the back side of the core block of the secondary resonator A compensates for the decrease in the magnetic coupling between the ends on the back side. Thereby, a high coupling coefficient state is maintained.

Here, in the case where, in both the secondary resonator A and the primary resonator B, the coils are wound at positions deviated from the centers of the core blocks, preferably, the core blocks should be placed such that the front-back directions of the longer parts and shorter parts are the same for the two coils. Thereby, it is expected that the degradation of the coupling coefficient by the position shift is reduced.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A resonator comprising:
a first magnetic material core including at least one core block of magnetic material;
a first winding wound around the first magnetic material core; and
a first protruding portion formed so as to protrude from a part of the core block between a first end of the core block and the first winding.

2. The resonator according to claim 1, wherein
the resonator is disposed so as to be opposed to a different resonator, the different resonator comprising a magnetic material core including at least one core block of magnetic material and a winding wound around the magnetic material core,
a first distance is defined as a distance from a center of a core block part wound by the first winding in a longitudinal direction of the core block to the first end of the core block,
a second distance is defined as a distance from a center of a core block part wound by the winding in a longitudinal direction of the core block in the different resonator to one end of the core block in the different resonator, said one end of the core block in the different resonator being on same side as a second end of the core block of the first magnetic material core on an opposite side to the first end with respect to the first winding, and
the first protruding portion is formed between the first end and a position apart from the first end in the longitudinal direction of the core block of the first magnetic material core by a distance obtained by subtracting one-half of the second distance from the first distance.

3. The resonator according to claim 1, wherein
the first protruding portion is formed of a magnetic material having a greater coercive force than the core block.

4. The resonator according to claim 1, further comprising,
a second protruding portion formed so as to protrude from a part of the core block between the first winding and a second end of the core block on an opposite side to the first end with respect to the first winding.

5. The resonator according to claim 4, wherein
the resonator is disposed so as to be opposed to a different resonator comprising a magnetic material core including at least one core block of magnetic material and a winding wound around the magnetic material core,
a third distance is defined as a distance from a center of a core block part wound by the first winding in a longitudinal direction of the core block to the second end of the core block, and
a fourth distance is defined as a distance from a center of a core block part wound by the winding in a longitudinal direction of the core block in the different resonator, to one end of the core block of the magnetic material core in the different resonator, said one end of the core block in the different resonator being on same side as the first end of the core block of the first magnetic material core,
the second protruding portion is formed between the second end and a position apart from the second end in the longitudinal direction of the core block of the first magnetic material core by a distance obtained by subtracting one-half of the fourth distance from the third distance.

6. The resonator according to claim 4, wherein
the second protruding portion is formed of a magnetic material having a greater coercive force than the core block of the first magnetic material core.

7. A wireless power transmission device to transmit power between a first resonator and a second resonator that are disposed so as to be opposed to each other, wherein
the first resonator comprises:
a first magnetic material core including at least one core block of magnetic material;
a first winding wound around the first magnetic material core; and
a first protruding portion formed so as to protrude from a part of the core block between a first end of the core block and the first winding and
the second resonator comprises:
a second magnetic material core including at least one core block of magnetic material;
a second winding wound around the second magnetic material core; and
a second protruding portion formed so as to protrude from a part of the core block of the second magnetic material core between the second winding and a first end of the core block of the second magnetic material core, the first end of the core block of the second magnetic material being on same side as a second end of the core block of the first magnetic material core, the second end being on an opposite side to the first end of the core block of the first magnetic material with respect to the first winding.

8. The wireless power transmission device according to claim 7, wherein
a first distance is defined as a distance from a center of a core block part wound by the first winding in a longitudinal direction of the core block to the first end of the core block of the first magnetic material core, and
a second distance is defined as a distance from a center of a core block part wound by of the second winding in a longitudinal direction of the core block to the first end of the core block of the second magnetic material core,
the first protruding portion is formed between the first end of the core block of the first magnetic material core and a position apart from the first end in the longitudinal direction of the core block of the first magnetic material core by a distance obtained by subtracting one-half of the second distance from the first distance,
the second protruding portion is formed between the first end of the core block of the second magnetic material core and a position apart from the first end in the longitudinal direction of the core block of the second magnetic material core by one-half of the second distance and
a length of the core block of the first magnetic material core is longer than that of the core block of the second magnetic material core.

9. The wireless power transmission device according to claim 7, wherein
the first protruding portion or the second protruding portion is formed of a magnetic material having a greater coercive force than the core block of the first magnetic material core or the core block of the second magnetic material core.

10. The wireless power transmission device according to claim 7, further comprising,
a third protruding portion formed so as to protrude from a part of the core block of the first magnetic material core between the first winding and the second end of the core block of the first magnetic material core, and
a fourth protruding portion formed so as to protrude from a part of the core block of the second magnetic material core between the second winding and a second end of the core block of the second magnetic material core on an opposite side to the first end of the core block of the second magnetic material core with respect to the second winding.

11. The wireless power transmission device according to claim 10, wherein
a third distance is defined as a distance from a center of a core block part wound by the first winding in a longitudinal direction of the core block to the second end of the core block of the first magnetic material core, and
a fourth distance is defined as a distance from a center of a core block part wound by the second winding in a longitudinal direction of the core block to the second end of the core block of the second magnetic material core,
the third protruding portion is formed between the second end of the core block of the first magnetic material core and a position apart from the second end in the longitudinal direction of the core block of the first magnetic material core by a distance obtained by subtracting one-half of the fourth distance from the third distance, and,
the fourth protruding portion is formed between the second end of the core block of the second magnetic material core and a position apart from the second end in the longitudinal direction of the core block of the second magnetic material core by one-half of the fourth distance and
a length of the core block of the first magnetic material core is longer than that of the core block of the second magnetic material core.

12. The wireless power transmission device according to claim 10, wherein
the third protruding portion or the fourth protruding portion is formed of a magnetic material having a greater coercive force than the core block of the first magnetic material core or the core block of the second magnetic material core.

13. A resonator comprising:
a first magnetic material core including at least one core block of magnetic material;
a first winding wound around the first magnetic material core; and
a first protruding portion formed so as to protrude from a part of the core block between a first end of the core block and the first winding, wherein
a first distance is defined as a distance from a center of a core block part wound by the first winding in a longitudinal direction of the core block to the first end of the core block,
the first protruding portion is formed between the first end and a position apart from the first end in the longitudinal direction of the core block by one-half of the first distance.
